(19) United States
(12) Patent Application Publication
(10) Pub. No.: US 2024/0387862 A1
(43) Pub. Date: Nov. 21, 2024

(54) SLURRY COMPOSITION FOR ALL-SOLID-STATE BATTERY PRODUCTION AND METHOD FOR PRODUCING ALL-SOLID-STATE BATTERY

(71) Applicant: SEKISUI CHEMICAL CO., LTD., Osaka (JP)

(72) Inventors: Jo OTSUKA, Yamaguchi (JP); Kenji YAMAUCHI, Shiga (JP)

(73) Assignee: SEKISUI CHEMICAL CO., LTD., Osaka (JP)

(21) Appl. No.: 18/578,531

(22) PCT Filed: Jul. 11, 2022
(86) PCT No.: PCT/JP2022/027177

§ 371 Date: Jan. 11, 2024

(30) Foreign Application Priority Data
Jul. 14, 2021 (JP) 2021-116463

(51) Int. Cl. H01M 10/0562

(52) U.S. Cl. CPC H01M 10/0562; H01M 2300/0071

(57) ABSTRACT

The present invention provides a slurry composition for all-solid-state battery production which can reduce gelation without neutralization with an acidic compound or a capital investment for a large-scale dry room or the like in the production of an all-solid-state battery using an alkali metal-containing inorganic powder, and which enables easy debinding of the binder resin and firing at relatively low temperature. The present invention also provides a method for producing an all-solid-state battery using the slurry composition for all-solid-state battery production. Provided is a slurry composition for all-solid-state battery production, containing: an organic solvent; a binder resin; and an alkali metal-containing inorganic powder, the binder resin containing a segment (A) derived from a (meth) acrylate having a C3-C20 branched alkyl group and at least one segment (B) selected from the group consisting of a segment derived from a (meth) acrylate having a C5-C20 cyclic hydrocarbon group and a segment derived from a compound having an aromatic group, the binder resin containing the segment (A) and the segment (B) in a total amount of 70% by weight or more.

### TECHNICAL FIELD

The present invention relates to slurry compositions for all-solid-state battery production and methods for producing all-solid-state batteries.

### BACKGROUND ART

Lithium-ion batteries, which have high energy densities and excellent charge and discharge cycle characteristics, are widely used as power sources for many electronic devices. However, lithium-ion batteries contain flammable organic solvents sealed therein and frequently cause accidents such as battery leakage and explosions. Recent studies therefore have focused on all-solid-state lithium-ion batteries (hereinafter also referred to as “all-solid-state batteries”) containing inorganic solid electrolytes. All-solid-state batteries are produced by a process called a wet process, which involves forming inorganic powder sheets with a uniform thickness by applying and drying a slurry composition containing an inorganic electrolyte and a binder resin that are dispersed in an organic solvent, laminating the sheets to form a battery, and firing the battery to remove the binder resin. The binder resin is necessary for thickness control by application or for sheet lamination, but needs to be removed by firing because residual binder in the laminate causes electric resistance and adversely affect the battery performance. For this reason, binder resins that have been used are acrylic resins, which have particularly excellent debinding properties, and polyvinyl acetal resins, which have excellent dispersing properties for inorganic powder and excellent sheet strength.

In recent years, the interfacial resistance between the electrolyte and the active material has become problematic for achieving a high-performance all-solid-state battery. To solve this problem, for example, Patent Literature 1 discloses an active material having a resistance-reduction coating layer that prevents formation of a resistive layer to reduce formation of high-resistance portions.

Patent Literature 2 discloses oxide particles having an alkaline compound, wherein the oxide particles have a neutralized product on part or all of the surface of the oxide particles so as to reduce the interfacial resistance.

Patent Literature 3 discloses a solid electrolyte slurry containing garnet-type solid electrolyte particles and lithium- and boron-containing compound particles as dispersoids dispersed in a dispersion medium.

### CITATION LIST

### Patent Literature

Patent Literature 1: JP 2009-266728 A

Patent Literature 2: JP 5825455 B

Patent Literature 3: JP 2021-51912 A

### SUMMARY OF INVENTION

### Technical problem

In Patent Literature 1, however, the active material is coated with an alkali metal-containing compound, which may make the resulting slurry composition strongly alkaline and cause gelation of the binder resin.

In Patent Literature 2, the oxide particles are coated with a neutralized product by surface treatment. Even with such a method, the resulting slurry is strongly alkaline, which may cause gelation of the binder resin.

In Patent Literature 3, the moisture content of the organic solvent as the dispersion medium needs to be decreased to 0.007% by mass or lower to prevent decomposition of the lithium-and boron-containing compound by moisture. This requires controlling the entire production equipment in an absolute dry state, leading to a high cost of production equipment. There is thus a need for a slurry that is easier to produce.

The present invention aims to provide a slurry composition for all-solid-state battery production which can reduce gelation without neutralization with an acidic compound or a capital investment for a large-scale dry room or the like in the production of an all-solid-state battery using an alkali metal-containing inorganic powder, and which enables easy debinding of the binder resin and firing at relatively low temperature. The present invention also aims to provide a method for producing an all-solid-state battery using the slurry composition for all-solid-state battery production.

### Solution to problem

The present disclosure (1) relates to a slurry composition for all-solid-state battery production, containing: an organic solvent; a binder resin; and an alkali metal-containing inorganic powder, the binder resin containing a segment (A) derived from a (meth) acrylate having a C3-C20 branched alkyl group and at least one segment (B) selected from the group consisting of a segment derived from a (meth) acrylate having a C5-C20 cyclic hydrocarbon group and a segment derived from a compound having an aromatic group, the binder resin containing the segment (A) and the segment (B) in a total amount of 70% by weight or more.

The present disclosure (2) relates to the slurry composition for all-solid-state battery production of the present disclosure (1), wherein the binder resin contains 20 to 90% by weight of the segment (A).

The present disclosure (3) relates to the slurry composition for all-solid-state battery production of the present disclosure (1) or (2), wherein the binder resin contains 10 to 80% by weight of the segment (B).

The present disclosure (4) relates to the slurry composition for all-solid-state battery production of any one of the present disclosures (1) to (3), wherein the slurry composition has a pH of 11 or higher.

The present disclosure (5) relates to the slurry composition for all-solid-state battery production of any one of the present disclosures (1) to (4), wherein the inorganic powder contains lithium.

The present disclosure (6) relates to a method for producing an all-solid-state battery, including the steps of: preparing an inorganic powder sheet using the slurry composition for all-solid-state battery production of any one of the present disclosures (1) to (5); and firing the inorganic powder sheet at 600° C. or lower.

The present inventors have found out that the use of a binder resin containing specific segments can reduce gelation without neutralization with an acidic compound or a capital investment for a large-scale dry room or the like in the production of an all-solid-state battery using an alkali metal-containing inorganic powder, and enables easy debinding of the binder resin and firing at relatively low temperature. The inventors thus completed the present invention.

### <Binder Resin>

The slurry composition for all-solid-state battery production of the present invention contains a binder resin.

The binder resin contains a segment (A) derived from a (meth)acrylate having a C3-C20 branched alkyl group and at least one segment (B) selected from the group consisting of a segment derived from a (meth)acrylate having a C5-C20 cyclic hydrocarbon group and a segment derived from a compound having an aromatic group. The binder resin contains the segment (A) and the segment (B) in a total amount of 70% by weight or more.

The use of the binder resin can reduce gelation without neutralization with an acidic compound or a capital investment for a large-scale dry room or the like in the production of an all-solid-state battery using an alkali metal-containing inorganic powder, and enables easy debinding of the binder resin and firing at relatively low temperature.

Examples of the (meth)acrylate having a C3-C20 branched alkyl group include isopropyl (meth)acrylate, isobutyl (meth)acrylate, sec-butyl (meth)acrylate, tert-butyl (meth)acrylate, isooctyl (meth)acrylate, 2-ethylhexyl (meth)acrylate, isononyl (meth)acrylate, isodecyl (meth)acrylate, and isostearyl (meth)acrylate.

Preferred among these are isobutyl (meth)acrylate, 2-ethylhexyl (meth)acrylate, isononyl (meth)acrylate, isodecyl (meth)acrylate, and isostearyl (meth)acrylate. More preferred are isobutyl methacrylate, 2-ethylhexyl methacrylate, isononyl methacrylate, isodecyl methacrylate, and isostearyl methacrylate.

The carbon number of the C3-C20 branched alkyl group is 3 or greater, preferably 5 or greater, more preferably 6 or greater, still more preferably 8 or greater and is 20 or less, preferably 18 or less, more preferably 15 or less, still more preferably 12 or less. When the carbon number of the C3-C20 branched alkyl group is within the range, the gelation under alkaline conditions can be further reduced while the slurry composition for all-solid-state battery production can have good handleability.

The amount of the segment (A) derived from a (meth)acrylate having a C3-C20 branched alkyl group in the binder resin is preferably 20% by weight or more, more preferably 30% by weight or more, still more preferably 35% by weight or more and is preferably 90% by weight or less, more preferably 80% by weight or less, still more preferably 70% by weight or less. When the amount of the segment (A) derived from a (meth)acrylate having a C3-C20 branched alkyl group is within the range, gelation under alkaline conditions can be further reduced while the resulting inorganic powder sheet can have sufficiently high plasticity and sufficiently high low-temperature decomposability and the slurry composition for all-solid-state battery production can have good handleability.

A homopolymer of the (meth)acrylate having a C3-C20 branched alkyl group preferably has a glass transition temperature (Tg) of −50° C. or higher, more preferably −45° C. or higher and preferably 110° C. or lower, more preferably 50° C. or lower, still more preferably 0° C. or lower.

The Tg of the homopolymer can be measured using a differential scanning calorimeter (DSC), for example.

Examples of the (meth)acrylate having a C5-C20 cyclic hydrocarbon group include a (meth)acrylate having a C5-C20 alicyclic hydrocarbon group and a (meth)acrylate having a C5-C20 aromatic hydrocarbon group.

Examples of the (meth)acrylate having a C5-C20 alicyclic hydrocarbon group include cyclopentyl (meth)acrylate, norbornyl (meth)acrylate, isobornyl (meth)acrylate, cyclohexyl (meth)acrylate, dicyclopentanyl (meth)acrylate, 2-methyl-2-adamantyl (meth)acrylate, and 2-ethyl-2-adamantyl (meth)acrylate.

Examples of the (meth)acrylate having a C5-C20 aromatic hydrocarbon group include phenyl (meth)acrylate, benzyl (meth)acrylate, phenoxyethyl (meth)acrylate, and phenoxydiethylene glycol (meth)acrylate.

Preferred among these are isobornyl (meth)acrylate, benzyl (meth)acrylate, and cyclohexyl (meth)acrylate. More preferred are isobornyl methacrylate, benzyl methacrylate, and cyclohexyl methacrylate.

The carbon number of the C5-C20 cyclic hydrocarbon group is 5 or greater, preferably 6 or greater, more preferably 8 or greater and is 20 or less, preferably 18 or less, more preferably 15 or less, still more preferably 12 or less, further preferably 10 or less, particularly preferably 8 or less, especially preferably 7 or less, most preferably 6 or less.

The C5-C20 cyclic hydrocarbon group may be a polycyclic hydrocarbon group or a monocyclic hydrocarbon group but is preferably a monocyclic hydrocarbon group. The C5-C20 cyclic hydrocarbon group may be an aromatic hydrocarbon group or an alicyclic hydrocarbon group but is preferably an alicyclic hydrocarbon group.

The amount of the segment derived from a (meth)acrylate having a C5-C20 cyclic hydrocarbon group in the binder resin is preferably 5% by weight or more, more preferably 10% by weight or more, still more preferably 20% by weight or more and is preferably 80% by weight or less, more preferably 70% by weight or less, still more preferably 65% by weight or less. When the amount of the segment derived from a (meth)acrylate having a C5-C20 cyclic hydrocarbon group in the binder resin is within the range, gelation under alkaline conditions can be further reduced while the resulting inorganic powder sheet can have sufficiently high strength and sufficiently high low-temperature decomposability and the slurry composition for all-solid-state battery production can have good handleability.

A homopolymer of the (meth)acrylate having a C5-C20 cyclic hydrocarbon preferably has a glass transition temperature (Tg) of 50° C. or higher, more preferably 60° C. or higher and preferably 190° C. or lower, more preferably 70° C. or lower.

The Tg of the homopolymer can be measured using a differential scanning calorimeter (DSC), for example. The compound having an aromatic group differs from the (meth)acrylate having a C5-C20 aromatic hydrocarbon group.

Examples of the compound having an aromatic group include aromatic vinyl compounds.

Examples of the aromatic vinyl compounds include styrene, α-methylstyrene, o-, m-, or p-methylstyrene, vinylxylene, p-t-butylstyrene, and ethylstyrene.

Preferred among these is styrene.

A homopolymer of the compound having an aromatic group preferably has a glass transition temperature (Tg) of 60° C. or higher, more preferably 80° C. or higher and preferably 140° C. or lower, more preferably 120° C. or lower.

The Tg of the homopolymer can be measured using a differential scanning calorimeter (DSC), for example.

The segment derived from a compound having an aromatic group may be an aromatic ester unit obtained by condensation of an aromatic dicarboxylic acid having an aromatic group with a diol.

Examples of the dicarboxylic acid include o-phthalic acid, terephthalic acid, isophthalic acid, succinic acid, adipic acid, sebacic acid, azelaic acid, octylsuccinic acid, cyclohexanedicarboxylic acid, naphthalenedicarboxylic acid, fumaric acid, maleic acid, itaconic acid, and decamethylenecarboxylic acid.

Examples of the diol include aliphatic diols such as ethylene glycol, 1,3-propanediol, 1,4-butanediol, diethylene glycol, 1,5-pentanediol, 1,6-hexanediol, dipropylene glycol, triethylene glycol, tetraethylene glycol, 1,2-propanediol, 1, 3-butanediol, 2,3-butanediol, neopentylglycol (2,2-dimethylpropane-1,3-diol), 1,2-hexanediol, 2,5-hexanediol, 2-methyl-2,4-pentanediol, 3-methyl-1,3-pentanediol, and 2-ethyl-1,3-hexanediol.

Preferred among these is an ethylene terephthalate unit obtained from terephthalic acid as the dicarboxylic acid and ethylene glycol as the diol.

Examples of a polymer constituted by the aromatic ester unit include polyethylene terephthalate and polybutylene terephthalate.

The polymer constituted by the aromatic ester unit preferably has a glass transition temperature of 40° C. or higher, more preferably 50° C. or higher and preferably 80° C. or lower, more preferably 70° C. or lower.

The Tg of the homopolymer can be measured using a differential scanning calorimeter (DSC), for example.

The amount of the segment derived from a compound having an aromatic group in the binder resin is preferably 0% by weight or more, more preferably 5% by weight or more and is preferably 40% by weight or less, more preferably 20% by weight or less.

The amount of at least one segment (B) selected from the group consisting of the segment derived from a (meth)acrylate having a C5-C20 cyclic hydrocarbon group and the segment having an aromatic group means the total amount of the segment derived from a (meth)acrylate having a C5-C20 cyclic hydrocarbon group and the segment having an aromatic group.

The amount of the segment (B) is preferably 5% by weight or more, more preferably 10% by weight or more and is preferably 80% by weight or less, more preferably 70% by weight or less. When the amount of the segment (B) in the binder resin is within the range, the resulting inorganic powder sheet can have sufficiently high strength, and the slurry composition for all-solid-state battery production can have good handleability.

The total amount of the segment (A) and the segment (B) in the binder resin is 70% by weight or more.

When the total amount is 70% by weight or more, the use of the binder resin can reduce gelation without neutralization with an acidic compound or a capital investment for a large-scale dry room or the like in the production of an all-solid-state battery using an alkali metal-containing inorganic powder, and enables easy debinding of the binder resin and firing at relatively low temperature.

The total amount is preferably 75% by weight or more, more preferably 80% by weight or more, still more preferably 85% by weight or more, further preferably 90% by weight or more, particularly preferably 95% by weight or more, and is usually 100% by weight or less.

The binder resin preferably has a ratio of the amount of the segment (A) to the amount of the segment (B) (amount of segment (A)/amount of segment (B)) of 0.25 or greater, more preferably 0.4 or greater and preferably 18 or less, more preferably 9 or less. When the ratio of the amount of the segment (A) to the amount of the segment (B) in the binder resin is within the range, the resulting inorganic powder sheet can have sufficiently high toughness and sufficiently high low-temperature decomposability, and the slurry composition for all-solid-state battery production can have good handleability.

The binder resin may contain a segment (C) other than the segment (A) and the segment (B), such as a segment derived from a (meth)acrylate having a linear alkyl group, a segment derived from a (meth)acrylate having a C21 or higher branched alkyl group, a segment derived from a (meth)acrylate having a C3-C4 cyclic hydrocarbon group, a segment derived from a (meth)acrylate having a C21 or higher cyclic hydrocarbon group, or a (meth)acrylate having a polar group.

From the standpoint of the sinterability at low temperature and reduced gelation under alkaline conditions, the binder resin preferably does not contain a segment derived from a (meth)acrylate having a glycidyl group and preferably does not contain a segment derived from a (meth)acrylate having a linear alkyl group.

Examples of the (meth)acrylate having a linear alkyl group include methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, decyl (meth)acrylate, undecyl (meth)acrylate, dodecyl (meth)acrylate, tridecyl (meth)acrylate, tetradecyl (meth)acrylate, pentadecyl (meth)acrylate, and hexadecyl (meth)acrylate.

Examples of the (meth)acrylate having a C21 or higher branched alkyl group include isoheneicosane (meth)acrylate.

Examples of the (meth)acrylate having a C3-C4 cyclic hydrocarbon group include cyclopropyl (meth)acrylate and cyclobutyl (meth)acrylate.

Examples of the (meth)acrylate having a C21 or higher cyclic hydrocarbon group include a (meth)acrylate having a cyclohenicosane group.

Examples of the (meth)acrylate having a polar group include a (meth)acylate having a polar group such as a hydroxy group, an amide group, or an amino group.

Examples of a (meth)acrylate having a hydroxy group include 2-hydroxyethyl (meth)acrylate and hydroxypropyl (meth)acrylate.

Examples of a (meth)acrylate having an amide group include N, N-dimethylaminopropyl (meth)acrylamide, N,N-dimethyl (meth)acrylamide, (meth)acryloylmorpholine, N-isopropyl (meth)acrylamide, and N-hydroxyethyl (meth)acrylamide.

Examples of the (meth)acrylate having an amide group or an amino group include N-dialkylaminoalkyl (meth)acrylamide and N,N-dialkylaminoalkyl (meth)acrylamide.

The amount of the segment (C) in the binder resin is preferably 30% by weight or less, more preferably 20% by weight or less, still more preferably 15% by weight or less, further preferably 108 by weight or less, particularly preferably 5% by weight or less, especially preferably 3% by weight or less.

The binder resin preferably has a melt flow index (MFR value) of 10 g/10 min or less as determined in conformity with ISO-1133.

The MFR value is preferably 8 g/10 min or less, more preferably 6 g/10 min or less, still more preferably 4 g/10 min or less. The lower limit thereof is not limited. For example, the lower limit is 0 g/10 min or greater.

When the MFR value is not higher than the upper limit, the resulting inorganic powder sheet can have sufficiently high strength, so that the inorganic powder sheet can be thinner while having excellent handleability. The lower limit of the polystyrene-equivalent weight average molecular weight of the binder resin is preferably 100,000, and the upper limit thereof is preferably 3,000,000.

When the weight average molecular weight is 100,000 or greater, the slurry composition for all-solid-state battery production can have sufficient viscosity. When the weight average molecular weight is 3,000,000 or less, printability can be improved.

The lower limit of the weight average molecular weight is more preferably 200, 000, and the upper limit thereof is more preferably 1, 500, 000.

The binder resin particularly preferably has a polystyrene-equivalent weight average molecular weight of 200,000 to 1,500,000 because such a binder resin can ensure sufficient viscosity in a small amount when used with the later-described organic solvent, while reducing stringing in the resulting slurry composition.

The lower limit of the polystyrene-equivalent number average molecular weight of the binder resin is preferably 33,000, more preferably 80, 000, and the upper limit thereof is preferably 450, 000, more preferably 350,000.

The binder resin preferably has a ratio (Mw/Mn) of the weight average molecular weight (Mw) to the number average molecular weight (Mn) of 2 or greater and 8 or less.

The binder resin having a Mw/Mn within such a range appropriately contains components with low degrees of polymerization, which allows the slurry composition for all-solid-state battery production to have a viscosity in a suitable range, leading to high productivity. Such a binder resin also allows the resulting inorganic powder sheet to have appropriate sheet strength.

The binder resin having a Mw/Mn of less than 2 may result in poor leveling properties in application and poor smoothness of the inorganic powder sheet. The binder resin having a Mw/Mn of greater than 8 contains more high molecular weight components, which may cause the inorganic powder sheet to have poor drying properties and in turn poor surface smoothness.

The Mw/Mn is more preferably 3 or greater and 8 or less.

The polystyrene-equivalent weight average molecular weight and number average molecular weight can be measured by GPC using Column LF-804 (available from Showa Denko K.K.) as a column, for example.

The binder resin preferably has a glass transition temperature (Tg) of −40° C. or higher, more preferably −20° C. or higher, still more preferably 9° C. or higher. The binder resin preferably has a glass transition temperature (Tg) of lower than 105° C., more preferably lower than 75° C., still more preferably lower than 40° C.

When the glass transition temperature is within the range, the plasticizer can be added in a smaller amount, which can improve the low-temperature decomposability of the binder resin.

The Tg can be measured using a differential scanning calorimeter (DSC), for example.

The amount of the binder resin in the slurry composition for all-solid-state battery production of the present invention is preferably 18 by weight or more, more preferably 2% by weight or more, still more preferably 4% by weight or more and is preferably 20% by weight or less, more preferably 10% by weight or less, still more preferably 8% by weight or less.

The binder resin may be produced by any method and may be produced as follows, for example. A raw material monomer mixture containing a (meth)acrylate having a C3-C10 branched alkyl group, a (meth)acrylate having a C5-C20 cyclic hydrocarbon group, and a compound having an aromatic group is added to an organic solvent or the like to prepare a monomer mixture solution. To the obtained monomer mixture solution is then added a polymerization initiator to copolymerize the raw material monomers.

The polymerization method is not limited. Examples thereof include emulsion polymerization, suspension polymerization, bulk polymerization, interfacial polymerization, and solution polymerization. Preferred among these is solution polymerization.

Examples of the polymerization initiator include p-menthane hydroperoxide, diisopropylbenzene hydroperoxide, 1,1,3,3-tetramethylbutyl hydroperoxide, cumene hydroxyperoxide, t-butyl hydroxyperoxide, cyclohexanone peroxide, and disuccinic acid peroxide.

Commercially available examples of these polymerization initiators include PERMENTA H, PERCUMYL P, PEROCTA H, PERCUMYL H-80, PERBUTYL H-69, PERHEXA H, and PEROYL SA (all available from NOF Corporation).

Another embodiment of the present invention provides a binder resin having a hydrolyzability of 15% or lower. The hydrolyzability is preferably 10% or lower, more preferably 8% or lower, still more preferably 5% or lower, further preferably 3% or lower, particularly preferably 1.5% or lower, and for example 0% or higher. When the hydrolyzability is not higher than the upper limit, the gelation-reducing effect can be higher. Reducing the gelation can improve the dispersibility of the inorganic powder, enabling the production of an all-solid-state battery having high battery performance.

The hydrolyzability can be measured by the following method, for example.

First, the binder resin is dissolved in ethyl acetate to provide a solution having a resin solid content of 15% by weight. This solution is applied to a PET release film having a length of 50 mm and a width of 50 mm. Next, the solution is dried at 100° C. for five minutes to remove the solvent and separated from the PET release film to provide a film-form binder resin having a length of 50 mm, a width of 50 mm, and a thickness of 50 μm. This film-form binder resin is immersed in 10 g of a 0.1 mol/L sodium hydroxide aqueous solution at 80° C. for one week and then subjected to nuclear magnetic resonance (NMR) measurement to determine the amount of alcohol produced by hydrolysis. The hydrolyzability can be determined by the following formula (1).

$$Hydroyzability ( \% ) = ( A 1 / A 2 ) \times 100 \qquad ( 1 )$$

In the formula (1), A1 represents the number of moles of the produced alcohol, and A2 represents the number of moles of the binder resin in terms of monomer.

The number of moles of the binder resin in terms of monomer can be determined by the following formula (2).

$$Number of moles of binder resin in terms of monomer = \sum ( B \times {r}_{i} / {M}_{i} ) \qquad ( 2 )$$

In the formula (2), B represents the weight of the binder resin in the specimen, rᵢ represents the proportion of a monomer i component in the binder resin, and Mᵢ represents the molecular weight of the monomer of the i component.

The binder resin having a hydrolyzability of 15% or lower may be, for example, the above-described binder resin (particularly a (meth)acrylic resin) containing the segment (A) and the segment (B) in a total amount of 70% by weight or more. The binder resin can be obtained by the above-described method for producing the binder resin.

### <Organic Solvent>

The slurry composition for all-solid-state battery production of the present invention contains an organic solvent.

The organic solvent is preferably at least one selected from the group consisting of an aromatic compound, an aliphatic hydrocarbon, an alicyclic hydrocarbon, and an acetate compound, for example.

The slurry composition containing the organic solvent can be advantageously excellent in properties such as the application properties, the drying properties, and the dispersibility of the inorganic powder in the production of the inorganic powder sheet.

Examples of the aromatic compound include aromatic hydrocarbons such as benzene and alkylbenzenes (e.g., toluene, xylene, mesitylene, methylbenzyl xylene, 1 4-dimethyl-2-(1-phenylethyl) benzene, and ethylbenzene), aromatic alcohols such as phenol, benzyl alcohol, and cresol, and aromatic ketones such as acetophenone.

Examples of the aliphatic hydrocarbons include hexane, n-heptane, isopentane, n-octane, n-nonane, and n-decane, as well as olefinic solvents such as normalparaffin, isoparaffin, a-olefin, and isobutylene derivatives. Preferred aromatic compounds are aromatic hydrocarbons and aromatic alcohols.

Examples of the alicyclic hydrocarbons include limonene, dipentene, terpinene, nesol, cinene, orange flavor, terpinolene, phellandrene, menthadiene, terebene, dihydrocymene, moslene, isoterpinene, crithmene, kautschin, cajeputene, eulimen, pinene, turpentine, menthane, pinane, terpene, cyclohexane, and alkyl cyclohexanes such as methylcyclohexane.

Examples of the acetate compound include ethyl acetate, butyl acetate, and hexyl acetate.

Preferred among these are toluene, xylene, butyl acetate, and hexyl acetate.

These organic solvents may be used alone or in combination of two or more thereof.

The organic solvent preferably has a boiling point of 100° C. or higher, more preferably 110° C. or higher and preferably 240° C. or lower, more preferably 220° C. or lower, still more preferably 200° C. or lower, further preferably 190° C. or lower.

The organic solvent having a boiling point not lower than the lower limit does not evaporate too fast, which further improves the handleability. When the boiling point is not higher than the upper limit, the inorganic powder sheet contains less residual organic solvent, which can improve the sheet strength and also further improve the printability.

The amount of the organic solvent in the slurry composition for all-solid-state battery production of the present invention is preferably 10% by weight or more, more preferably 20% by weight or more, still more preferably 30% by weight or more, further preferably 40% by weight or more and is preferably 70% by weight or less, more preferably 60% by weight or less.

The solvent in an amount within the range can improve the application properties and the dispersibility of the inorganic powder.

### <Inorganic Powder>

The slurry composition for all-solid-state battery production of the present invention contains an inorganic powder.

The inorganic powder contains an alkali metal. Containing the inorganic powder, the slurry composition can sufficiently increase the properties of the resulting battery.

Alkali metals are lithium, sodium, potassium, rubidium, cesium, and francium. Lithium is preferred. Examples of the alkali metal-containing inorganic powder include sulfide materials such as Li₂S-P₂S₅ materials, Li₂S-GeS₂ materials, Li₂S-GeS₂-P₂S₅ materials, Li₂S-SiS₂ materials, Li₂S-B₂S₃ materials, and Li₃PO₄-P₂S₅ materials. Examples also include those obtained by adding a lithium halide to any of the above sulfide materials (e.g., LiI-Li₂S-PS₅, LiCl-LiI-Li₂S-PS₅, LiBr-LiI-LiS-PS₅, LiI-LiS-SiSe, and LiI-Li₂S-B₂S₃). In particular, sulfide inorganic powders of Li₂S-P₂S₅ materials are preferred because they do not contain any expensive rare earth element and have high ionic conductivity.

To design a high-capacity battery, an active material made of a Li-containing alkali metal oxide is preferably used. Specific examples thereof include composite oxide materials, including lithium-lanthanum-zirconium-containing composite oxides (LLZ materials) such as Li₇La₃Zr₂O₁₂, Al-doped LLZO, lithium-lanthanum-titanium-containing composite oxides (LLT materials), Al-doped LLT materials, and lithium phosphate. Examples also include lithium cobalt oxide, lithium nickel oxide, lithium-nickel-cobalt-aluminum oxide, lithium-nickel-manganese-cobalt oxide, and lithium-manganese-nickel compounds.

The inorganic powder may be coated with a lithium metal compound.

Any lithium metal compound may be used for coating. Examples thereof include lithium niobate, lithium titanate, lithium silicate, lithium borosilicate, lithium borate, lithium phosphate, and lithium phosphite.

The amount of the inorganic powder in the slurry composition for all-solid-state battery production of the present invention is not limited. The lower limit of the amount is preferably 10% by weight, more preferably 20% by weight, still more preferably 30% by weight. The upper limit thereof is preferably 90% by weight, more preferably 80% by weight, still more preferably 70% by weight, further preferably 60% by weight, particularly preferably 50% by weight. When the amount is not less than the lower limit, sufficient viscosity and excellent application properties can be achieved. When the amount is not more than the upper limit, excellent dispersibility of the inorganic powder is achieved.

### <Other Components>

The slurry composition for all-solid-state battery production of the present invention may further contain a plasticizer.

Examples of suitable plasticizers include a compound having a branched alkyl group, a compound having a cyclic hydrocarbon group, and a compound having three or more acyl groups.

Examples of the plasticizer include di (butoxyethyl) adipate, dibutoxyethoxyethyl adipate, diisononyl adipate, diisodecyl adipate, di-2-ethylhexyl phthalate, butylated benzyl phthalate, diisodecyl phthalate, triethylene glycol dibutyl, triethylene glycol bis(2-ethylhexanoate), triethylene glycol dihexanoate, triethyl acetylcitrate, tributyl acetylcitrate, diethyl acetylcitrate, dibutyl acetylcitrate, dibutyl sebacate, triacetin, diethyl acetyloxymalonate, diethyl ethoxymalonate, tripropionin, and pentaerythritol tetraacetate. Preferred among these are triethylene glycol bis(2-ethylhexanoate), butylated benzyl phthalate, diisodecyl phthalate, di-2-ethylhexyl phthalate, diisononyl adipate, diisodecyl adipate, tripropionin, triacetin, and pentaerythritol acetate.

The plasticizer preferably has a boiling point of 240° C. or higher and lower than 390° C. A boiling point of 240° C. or higher allows the plasticizer to easily evaporate in the drying step, preventing residual plasticizer in the molded body. A boiling point of lower than 390° C. can prevent generation of residual carbon. The boiling point is a boiling point at normal pressure.

The amount of the plasticizer in the slurry composition for all-solid-state battery production of the present invention is not limited. The lower limit thereof is preferably 0.1% by weight, more preferably 0.5% by weight, and the upper limit thereof is preferably 3.0% by weight, more preferably 2.0% by weight. When the amount is within the range, firing residue of the plasticizer can be reduced.

The slurry composition for all-solid-state battery production of the present invention may further contain a sintering agent such as an organic peroxide. Examples of the organic peroxide include 1,1,3,3-tetramethylbutyl hydroperoxide, cumene hydroperoxide, t-butyl hydroperoxide, and 2,3-dimethyl-2,3-diphenylbutane.

The organic peroxide preferably has a ten-hour half-life temperature of 150° C. or higher.

The slurry composition for all-solid-state battery production of the present invention may further contain an additive such as a surfactant.

The surfactant is not limited. Examples thereof include cationic surfactants, anionic surfactants, and nonionic surfactants.

The nonionic surfactant is not limited but is preferably one having a HLB value of 10 or greater and 20 or less. The “HLB value” herein is an index of the hydrophilicity and lipophilicity of a surfactant. Several calculation methods have been proposed. For example, the HLB value for an ester surfactant is defined by 20 (1-S/A), where S is the saponification value and A is the acid value of fatty acid constituting the surfactant. Specifically, the nonionic surfactant is suitably a nonionic surfactant containing polyethylene oxide with an alkylene ether added to the aliphatic chain. Specific suitable examples include polyoxyethylene lauryl ether and polyoxyethylene cetyl ether. Although the nonionic surfactant is highly hydrolyzable, adding a large amount of it may decrease the hydrolyzability of the slurry composition for all-solid-state battery production. The upper limit of the amount of the nonionic surfactant is thus preferably 5% by weight.

The slurry composition for all-solid-state battery production of the present invention preferably has a pH of 11 or higher.

When the pH is 11 or higher, the slurry composition can sufficiently increase the performance of the resulting battery.

The pH can be determined using pH test paper, for example.

The slurry composition for all-solid-state battery production of the present invention may have any viscosity. The lower limit of the viscosity measured at 20° C. with a B-type viscometer at a probe rotation rate of 5 rpm is preferably 0.1 Pa·s, and the upper limit thereof is preferably 100 Pa·s.

A viscosity of 0.1 Pa·s or higher allows the resulting inorganic powder sheet to maintain a predetermined shape after application by a method such as die-coat printing. A viscosity of 100 Pa·s or lower can prevent defects such as permanent die discharge marks, leading to excellent printability.

The slurry composition for all-solid-state battery production of the present invention may be prepared by any method such as a conventionally known stirring method. Specifically, the slurry composition may be produced by, for example, stirring the binder resin, the inorganic powder, the organic solvent, and other optional components such as the plasticizer using a triple roll mill, a high-speed stirrer, or the like.

An inorganic powder sheet can be produced by applying the slurry composition for all-solid-state battery production of the present invention to a support film having one release-treated surface, drying the organic solvent, and forming the composition into a sheet.

The inorganic powder sheet preferably has a thickness of 1 to 20 μm.

The inorganic powder sheet may be produced by, for example, uniformly forming a coating film on the support film by applying the slurry composition for all-solid-state battery production of the present invention by a method such as a roll coater, a die coater, a squeeze coater, or a curtain coater.

The support film used for producing the inorganic powder sheet is preferably a heat-resistant, solvent-resistant, and flexible resin film. A flexible support film enables application of the slurry composition for all-solid-state battery production to the support film surface using a roll coater, a blade coater, or the like, and enables storage and supply of the resulting inorganic powder sheet on the film in a rolled state.

The support film may be made of a resin such as polyethylene terephthalate, polyester, polyethylene, polypropylene, polystyrene, polyimide, polyvinyl alcohol, polyvinyl chloride, fluororesin (e.g., polyfluoroethylene), nylon, or cellulose.

The support film preferably has a thickness of 20 to 100 μm, for example.

The support film is preferably release-treated at a surface thereof. This allows easy separation of the support film in the transferring step.

The inorganic powder sheet can be produced by applying and drying the slurry composition for all-solid-state battery production of the present invention. Further, the inorganic powder sheet may be fired to produce an all-solid-state battery. Moreover, the slurry composition for all-solid-state battery production of the present invention and the inorganic powder sheet may be used for dielectric green sheets and an electrode paste to produce a multilayer ceramic capacitor.

An example of the method for producing the all-solid-state battery is a method including the steps of: forming an electrode active material layer slurry into an electrode active material sheet, the slurry containing an electrode active material and a binder for an electrode active material layer; laminating the electrode active material sheet and the inorganic powder sheet to produce a laminate; and firing the laminate.

The electrode active material is not limited. Examples thereof include glass powder, ceramic powder, fluorescent material fine particles, silicon oxide, and metal fine particles.

Any glass powder may be used. Examples thereof include powders of glass such as bismuth oxide glass, silicate glass, lead glass, zinc glass, or boron glass, and various silicon oxide glass powders such as CaO-Al₂O₃-SiO₂ glass powder, MgO-Al₂O₃-SiO₂ glass powder, and LiO₂-Al₂O₃-SiO₂ glass powder.

Usable glass powders include SnO-B₂O₃-P-05-Al₂O₃ mixtures, PbO-B₂O₃-SiO₂ mixtures, BaO-ZnO-B₂O₃-SiO₂ mixtures, ZnO-Bi₂O₃-B₂O₃-SiO₂ mixtures, Bi₂O₃-B₂O₃-BaO-CuO mixtures, Bi₂O₃-ZnO-B₂O₃-Al₂O₃-SrO mixtures, ZnO-Bi₂O₃-B₂O₃ mixtures, Bi₂O₃-SiO₂ mixtures, P₂O₅-Na O-CaO-BaO-Al₂O₃-B₂O₃ mixtures, P₂O₅-SnO mixtures, P₂O₅-SnO-Bi₂O₃ mixtures, P₂O₅-SnO-SiO-mixtures, CuO-P₂O₅-RO mixtures, SiO₂B₂O₃ -ZnO-Na₂O-Li₂O-NaF-V₂O₅ mixtures, P₂O₅-ZnO-SnO-R₂O-RO mixtures, B₂O₃-SiO₂ -ZnO mixtures, B₂O₃-SiO₂-Al₂O₃-ZrO: mixtures, SiO -B₂O₃-ZnO-R₂O-RO mixtures, SiO₂-B₂O₃-Al₂O₃-RO-R₂O mixtures, Sro-ZnO-P₂O₅ mixtures, Sro-ZnO-P₂O₅ mixtures, and BaO-ZnO-B₂O₃-SiO₂ mixtures. R is an element selected from the group consisting of Zn, Ba, Ca, Mg, Sr, Sn, Ni, Fe, and Mn.

Particularly preferred are PbO-B₂O₃-SiO₂ mixture glass powders and lead-free glass powders such as BaO-ZnO-B₂O₃-SiO₂ mixtures or ZnO-Bi₂O₃-B₂O₃-SiO₂ mixtures.

Any ceramic powder may be used. Examples thereof include alumina, ferrite, zirconia, zircon, barium zirconate, calcium zirconate, titanium oxide, barium titanate, strontium titanate, calcium titanate, magnesium titanate, zinc titanate, lanthanum titanate, neodymium titanate, lead zirconate titanate, alumina nitride, silicon nitride, boron nitride, boron carbide, barium stannate, calcium stannate, magnesium silicate, mullite, steatite, cordierite, and forsterite.

Usable ceramic powders also include ITO, FTO, niobium oxide, vanadium oxide, tungsten oxide, lanthanum strontium manganite, lanthanum strontium cobalt ferrite, yttrium-stabilized zirconia, gadolinium-doped ceria, nickel oxide, and lanthanum chromite. Any phosphor fine particles may be used. For example, the phosphor may be a blue phosphor, a red phosphor, or a green phosphor conventionally known as a phosphor for displays. Examples of the blue phosphor include MgAl₁₀O₁₇: Eu phosphors, Y₂SiO₅: Ce phosphors, CaWO₄: Pb phosphors, BaMgAl₁₄O₂₃: Eu phosphors, BaMgAl₁₆O₂₇: Eu phosphors, BaMg₂Al₁₄O₂₃: Eu phosphors, BaMg₂Al₁₄O₁₇: Eu phosphors, and ZnS: (Ag, Cd) phosphors. Examples of the red phosphor include Y₂O₃: Eu phosphors, Y₂SiO₅: Eu phosphors, Y₃Al₅O₁₂: Eu phosphors, Zn₃(PO₄)₂:Mn phosphors, YBO₃: Eu phosphors, (Y, Gd)BO₃: Eu phosphors, GdBO₃: Eu phosphors, ScBO₃: Eu phosphors, and LuBO₃: Eu phosphors. Examples of the green phosphor include Zn₂SiO₄: Mn phosphors, BaAl₁₂O₁₉: Mn phosphors, SrAl₁₃O₁₉: Mn phosphors, CaAl₁₂O₁₉: Mn phosphors, YBO₃: Tb phosphors, BaMgAl₁₄O₂₃: Mn phosphors, LuBO₃: Tb phosphors, GdBO₃: Tb phosphors, ScBO₃: Tb phosphors, and Sr₆Si₃O₃Cl₄: Eu phosphors. Other usable phosphors include ZnO: Zn phosphors, ZnS: (Cu, Al) phosphors, ZnS: Ag phosphors, Y₂O₂S: Eu phosphors, ZnS:Zn phosphors, (Y, Cd)BO₃: Eu phosphors, and BaMgAl₁₄O₂₃: Eu phosphors.

Any metal fine particles may be used. Examples thereof include powders of copper, nickel, palladium, platinum, gold, silver, aluminum, and tungsten, and alloys thereof.

Metals such as copper and iron can also be suitably used. These are easily oxidized because of their good adsorption properties with a carboxy group, an amino group, an amide group, or the like. These metal powders may be used alone or in combination of two or more.

Metal complexes, various carbon blacks and carbon nanotubes, or the like may also be used. The electrode active material preferably contains lithium or titanium. Specific examples include low-melting-pointglass such as LiO₂·Al₂O₃SiO₂ inorganic glass, lithium sulfur glass such as Li₂S-MₓS_{y} (M=B, Si, Ge, or P), lithium cobalt complex oxides such as LicoO₂, lithium manganese complex oxides such as LiMno₄, lithium nickel complex oxides, lithium vanadium complex oxides, lithium zirconium complex oxides, lithium hafnium complex oxides, lithium silicophosphate (Li_{3.5}Si_{0.5}P_{0.5}O₄), titanium lithium phosphate (LiTi₂(PO₄)₃), lithium titanate (Li₄Ti₅O₁₂), Li_{4/3}Ti_{5/3}O₄, germanium lithium phosphate (LiGe₂(PO₄)₃), Li₂-SiS glass, Li₂GeS₄-Li₃PS₄ glass, LiSiO₃, LiMnO₂O₄, Li₂S-P₂S₅ glass/ceramics, Li₂O-SiO₂, Li₂O-V₂I₅-SiO₂, LiS-SiS₂-Li₄SiO₄ glass, ion conductive oxides such as LiPON, lithium oxide compounds such as Li₂O-P₂O₅-B₂O₃and Li₂O-GeO₂Ba, LiₓAl_{y}Ti_{z}(PO₄)₃ glass, LaₓLi_{y}TiO_{z} glass, LiₓGe_{y}P_{z}O₄ glass, Li₇La₃Zr₂O₁₂ glass, LiᵥSi_{w}PₓS_{y}Cl_{z} glass, lithium niobium oxides such as LiNbO₃, lithium alumina compounds such as Li-β-alumina, and lithium zinc oxides such as Li₁₄Zn (GeO₄)₄.

Examples of the binder for an electrode active material layer include polystyrene resins, polypropylene resins, and (meth)acrylic resins.

The electrode active material sheet and the inorganic powder sheet may be laminated by, for example, a method in which the formed sheets are thermocompression-bonded by hot pressing or thermally laminated.

In the firing step, the lower limit of the heating temperature is preferably 250° C., and the upper limit thereof is preferably 600° C.

The all-solid-state battery can be produced by the above-described production method.

The all-solid-state battery preferably has a laminated structure including a positive electrode layer containing a positive electrode active material, a negative electrode layer containing a negative electrode active material, and a solid electrolyte layer between the positive electrode layer and the negative electrode layer.

The present invention also encompasses a method for producing an all-solid-state battery, including the steps of: preparing an inorganic powder sheet using the slurry composition for all-solid-state battery production of the present invention; and firing the inorganic powder sheet at 600° C. or lower.

The multilayer ceramic capacitor may be produced by, for example, a method including the steps of: preparing dielectric sheets by printing and drying a conductive paste on the inorganic powder sheets; and laminating the dielectric sheets.

The conductive paste contains a conductive powder.

The conductive powder may be made of any conductive material. Examples of the material include nickel, palladium, platinum, gold, silver, copper, and alloys thereof. These conductive powders may be used alone of in combination of two or more thereof.

The conductive paste may be printed by any method. Examples of the method include screen printing, die-coat printing, offset printing, gravure printing, and ink-jet printing.

With the method for producing the multilayer ceramic capacitor, dielectric sheets printed with the conductive paste are laminated to provide the multilayer ceramic capacitor.

### Advantageous Effects of Invention

The present invention can provide a slurry composition for all-solid-state battery production which can reduce gelation without neutralization with an acidic compound or a capital investment for a large-scale dry room or the like in the production of an all-solid-state battery using an alkali metal-containing inorganic powder, and which enables easy debinding of the binder resin and firing at relatively low temperature. The present invention can also provide a method for producing an all-solid-state battery using the slurry composition for all-solid-state battery production.

### DESCRIPTION OF EMBODIMENTS

The present invention is more specifically described in the following with reference to, but not limited to, examples.

### Example 1

A separable flask equipped with a condenser, a temperature-adjustable oil bath, a nitrogen inlet tube, and a stirring blade was charged with 100 parts by weight of a raw material monomer mixture prepared in accordance with the formulation shown in Table 1 and 100 parts by weight of toluene as an organic solvent. The oil bath was set at 80° C., and 2.5 parts by weight of PEROYL L (available from NOF Corporation) was added as a polymerization initiator to polymerize the raw material monomer mixture. Evaluation of the resin solid content by a dry method showed that almost 100% of the monomers were polymerized into a polymer. After dilution with an additional 600 parts by weight of toluene, a vacuum pump and a solvent trap were set, and treatment with the vacuum pump was performed for one hour to recover the toluene containing a trace amount of unreacted monomers and moisture, whereby a resin solution having a resin solid content of 15% by weight was obtained. The resin solid content was evaluated by a dry method. The resin solution was weighed to a resin solid content of 4 parts by weight into a plastic container for a high-speed stirring device. Additional organic solvent was added to achieve the formulation shown in Table 1, and 1 part by weight of triethylene glycol bis(2-ethylhexanoate) (PL-1) was added. The container was sealed and rotated at high speed to uniformly mix the resin solution.

Subsequently, 40 parts by weight of Li₇La₃Zr₂O₁₂ (LLZ available from Toshima Manufacturing Co., Ltd.) as a conductive inorganic powder was added, and the container was sealed and rotated at high speed to disperse the inorganic powder, whereby a slurry composition for all-solid-state battery production was prepared. (Examples 2 to 20 and Comparative Examples 1 to 4)

A slurry composition for all-solid-state battery production was obtained as in Example 1 except that the amount of the polymerization initiator added and the formulation of the raw material monomer mixture were as shown in Table 1 and the type of the organic solvent and the plasticizer was changed as shown in Table 1.

Raw material monomers, plasticizers, and inorganic powders used in Examples 1 to 20 and Comparative Examples 1 to 4 are as follows.

### Raw Material Monomer

### (A) (Meth) Acrylate Having C3-C20 Branched Alkyl Group (Alkyl Group Carbon Number)

tBMA: tert-butyl methacrylate (4)
2EHMA: 2-ethylhexyl methacrylate (8)
iNMA: isononyl methacrylate (9)
iDMA: isodecyl methacrylate (10)
iSMA: isostearyl methacrylate (18)

### (B) (Meth) Acrylate Having C5-C20 Cyclic Hydrocarbon Group (Cyclic Hydrocarbon Group Carbon Number) or Compound Having Aromatic Group

St: styrene
iBoMA: isobornyl methacrylate (10)
BZMA: benzyl methacrylate (7)
CHMA: cyclohexyl methacrylate (6)

### (C) Other Monomers

nBMA: butyl methacrylate
MMA: methyl methacrylate
GMA: glycidyl methacrylate

### Plasticizer

PL-1: triethylene glycol bis(2-ethylhexanoate)
PL-2: butylated benzyl phthalate
PL-3: diisononyl adipate
PL-4: diisodecyl phthalate
PL-5: tripropionin
PL-6: pentaerythritol tetraacetate
PL-7: diisodecyl adipate
PL-8: di-2-ethylhexyl phthalate
PL-9: triacetin

### Inorganic Powder

LLZ: Li₇La₃Zr₂O₁₂ (available from Toshima Manufacturing Co., Ltd.)
LLT: lithium-lanthanum-titanium-containing composite oxide (available from Toho Titanium Co., Ltd.)

### Evaluation

The binder resins used in the examples and the comparative examples and the slurry compositions obtained in the examples and the comparative examples were evaluated as follows. Tables 1 and 2 show the results.

### (1) Glass Transition Temperature (Tg)

The glass transition temperature (Tg) of the obtained binder resin was measured using a differential scanning calorimeter (DSC). Specifically, the temperature was evaluated from-150° C. to 150° C. at a temperature-increase rate of 5° C./min in a nitrogen atmosphere at a flow rate of 50 mL/min.

### (2) Weight Average Molecular Weight (Mw), Number Average Molecular Weight (Mn), and Mw/Mn

The polystyrene-equivalent weight average molecular weight (Mw) and number average molecular weight (Mn) of the obtained binder resin were measured by gel permeation chromatography using Column LF-804 (available from SHOKO) as a column.

### (3) Hydrolyzability

The resin solution (resin solid content: 15% by weight) above was applied to a PET release film having a length of 50 mm and a width of 50 mm. Next, the resin solution was dried at 100° C. for five minutes and then separated from the PET release film to provide a film-form binder resin having a length of 50 mm, a width of 50 mm, and a thickness of 50 μm. This film-form binder resin was immersed in 10 g of a 0.1 mol/L sodium hydroxide aqueous solution at 80° C. for one week and then subjected to nuclear magnetic resonance (NMR) measurement to determine the amount of alcohol produced by hydrolysis. The hydrolyzability was determined by the following formula (1).

$$Hydroyzability ( \% ) = ( A 1 / A 2 ) \times 100 \qquad ( 1 )$$

In the formula (1), A1 represents the number of moles of the produced alcohol, and A2 represents the number of moles of the binder resin in terms of monomer.

The number of moles of the binder resin in terms of monomer was determined by the following formula (2).

$$Number of moles of binder resin in terms of monomer = \sum ( B \times {r}_{i} / {M}_{i} ) \qquad ( 2 )$$

In the formula (2), B represents the weight of the binder resin in the specimen, ri represents the proportion of a monomer i component in the binder resin, and Mi represents the molecular weight of the monomer of the i component.

### (4) pH of Slurry Composition

The obtained slurry composition was applied to pH test paper (available from Advantec) with a pipette. The pH of the slurry composition was measured based on the degree of the color change and evaluated in accordance with the following criteria. A low pH indicates a low alkali metal content in the slurry composition, suggesting a poor resulting battery performance.
A: The slurry composition had a pH of 11 or higher and was strongly alkaline.
B: The slurry composition had a pH of lower than 11 and was not strongly alkaline.

### (5) Gelation of Slurry Composition

The plastic container for a high-speed stirring device containing the slurry composition was opened in a room adjusted to a dew-point temperature of −30° C. and the slurry composition was stirred with a spatula. The gelation state of the slurry was observed and evaluated in accordance with the following criteria. Reducing gelation can improve the dispersibility of the inorganic powder, enabling the production of an all-solid-state battery having high battery performance.
A: The slurry was fluid and had no coagulant.
B: The slurry was fluid but coagulated after one hour and within two hours.
C: The slurry was fluid but coagulated within one hour.
D: The slurry had already gelled when the container was opened.

### (6) Printability of Slurry Composition

The slurry compositions that were fluid in “(5) Gelation of slurry composition” were each applied with an applicator to a Teflon® sheet secured on a glass plate in a dry room adjusted to a dew point of −30° C. The slurry composition was dried with an air flow oven set at 120° C. for 30 minutes to prepare an inorganic powder sheet. The inorganic powder sheet was evaluated in accordance with the following criteria. Excellent printability enables the production of a uniform sheet and a high-performance all-solid-state battery.
A: The application surface was smooth, and a dense sheet was prepared.
B: A defect such as fading, crawling, or blurring was observed.
C: The slurry composition showed no fluidity and was unable to be printed, or had poor fluidity and was unable to be applied with a uniform thickness.

### (7) Handleability of Inorganic Powder Sheet

The Teflon® sheet was removed from the inorganic powder sheet obtained in “(6) Printability of slurry composition”, and the inorganic powder sheet was put on a firing ceramic plate with tweezers. The state of the sheet was visually observed and evaluated in accordance with the following criteria. Excellent handleability enables easy production of an electrode, enabling easy production of a battery.
A: The specimen had no fracture or crack.
B: The specimen had a slight fracture or crack.
C: The specimen had a fracture or crack.
D: The specimen fractured into pieces.

### (8) Sinterability of Inorganic Powder Sheet

In “(7) Handleability of inorganic powder sheet”, the inorganic powder sheet on the ceramic plate was fired in an electric furnace. The firing was performed by debinding at 600° C. for 30 minutes followed by holding at 1,000° C. for five hours. A cross-section of the fired sheet was observed with an electron microscope and evaluated in accordance with the following criteria. High sinterability enables the production of a uniform sheet with less impurities, enabling the production of a higher-performance all-solid-state battery.
A: A dense inorganic powder sinter was obtained without voids or firing residue (soot).
B: Firing residue (soot) was observed at part of the sinter.
C: Voids or gaps caused by firing residue (soot) were observed in places.

### (9) Tensile Test

The obtained binder resin was applied to a release-treated PET film with an applicator and dried with an air flow oven at 100° C. for 10 minutes to prepare a resin sheet having a thickness of 20 μm. A strip-shaped specimen having a width of 1 cm was prepared using scissors and graph paper as a cover film.

The specimen was subjected to a tensile test at 23° C. and 50 RH using an autograph AG-IS (available from Shimadzu Corporation) at a chuck distance of 3 cm and a tensile speed of 10 mm/min, and the stress-strain properties (maximum stress and elongation at break) were determined.

### (10) TGDTA

The obtained slurry composition was put in a platinum pan for TG-DTA and heated from 30° C. at 5° C./min to evaporate the solvent and pyrolyze the resin and the plasticizer. Then, the time at which a loss of 90% of the weight (excluding the weight of the inorganic powder) occurred was measured as the decomposition end time.

TABLE 1

| | | Inorganic dispersion slurry composition | | | | | | | | |
|---|---|---|---|---|---|---|---|---|---|---|
| | | Binder resin | | | | | | | | |
| | Polymer- | Raw material monomer (parts by weight) | | | | | | | | |
| | ization | | | | | | (Meth)acrylate having cyclic | | | |
| | initiator | | | | | | hydrocarbon group or compound | | | |
| | (parts by | (Meth)acrylate having branched alkyl group | | | | | having aromatic group | | | |
| | weight) | tBMA | 2EHMA | iNMA | iDMA | iSMA | St | iBoMA | BZMA | CHMA |
| Example 1 | 2.5 | — | — | — | — | 65 | 5 | — | — | — |
| Example 2 | 0.1 | 40 | — | — | — | — | 40 | — | — | — |
| Example 3 | 2.2 | — | — | — | — | 35 | — | 50 | — | — |
| Example 4 | 0.1 | 25 | — | — | — | 25 | 20 | 20 | — | — |
| Example 5 | 2 | — | — | — | 90 | — | — | — | 5 | — |
| Example 6 | 1.6 | — | — | — | 90 | — | — | — | 10 | — |
| Example 7 | 1.8 | — | — | 20 | — | — | — | — | 80 | — |
| Example 8 | 0.4 | — | — | 80 | — | — | — | — | 20 | — |
| Example 9 | 2.2 | — | — | 30 | — | — | — | — | — | 70 |
| Example 10 | 0.5 | — | 70 | — | — | — | — | — | — | 30 |
| Example 11 | 2 | — | 35 | — | — | — | — | — | — | 65 |
| Example 12 | 2.5 | — | — | — | — | 65 | — | 5 | — | — |
| Example 13 | 0.1 | — | — | — | — | 15 | 55 | — | — | — |
| Example 14 | 2.2 | — | — | — | — | 95 | 5 | — | — | — |
| Example 15 | 0.1 | — | — | — | — | 15 | 85 | — | — | — |
| Example 16 | 2 | — | — | — | 55 | — | — | 15 | — | — |
| Example 17 | 1.6 | — | — | — | — | 65 | 5 | — | — | — |
| Example 18 | 1.8 | — | — | — | — | 65 | 5 | — | — | — |
| Example 19 | 0.4 | 25 | 10 | 10 | 10 | 10 | 5 | — | — | — |
| Example 20 | 2.2 | — | — | — | — | 35 | 15 | 15 | 10 | 10 |
| Comparative | 0.5 | — | — | — | — | — | — | — | — | — |
| Example 1 | | | | | | | | | | |
| Comparative | 2 | — | — | — | — | 55 | 10 | — | — | — |
| Example 2 | | | | | | | | | | |
| Comparative | 0.5 | — | — | — | — | 70 | — | — | — | — |
| Example 3 | | | | | | | | | | |
| Comparative | 2 | — | — | — | — | — | 70 | — | — | — |
| Example 4 | | | | | | | | | | |

| | Inorganic dispersion slurry composition | | | | | | | | |
|---|---|---|---|---|---|---|---|---|---|
| | Binder resin | | | | | | | | |
| | Raw material monomer | | | | | | | | |
| | (parts by weight) | | | | | | | Hydrolyz- | Amount |
| | Other monomers | | | Tg | Mw | Mn | Mw/ | ability | (% by |
| | nBMA | MMA | GMA | (° C.) | (×10⁴) | (×10⁴) | Mn | (%) | weight) |
| Example 1 | 30 | — | — | −3.2 | 10 | 3.3 | 3 | 14.8 | 4 |
| Example 2 | — | 20 | — | 103.8 | 300 | 37.5 | 8 | 12.4 | 4 |
| Example 3 | 15 | — | — | 61.7 | 20 | 5.7 | 3.5 | 10.3 | 4 |
| Example 4 | — | 10 | — | 74.2 | 290 | 41.4 | 7 | 8.5 | 4 |
| Example 5 | 5 | — | — | −35.1 | 30 | 7.1 | 4.2 | 4.9 | 4 |
| Example 6 | — | — | — | −34.1 | 50 | 9.4 | 5.3 | 3.1 | 4 |
| Example 7 | — | — | — | 28.6 | 40 | 8.9 | 4.5 | 2.5 | 4 |
| Example 8 | — | — | — | −28.5 | 180 | 27.7 | 6.5 | 1.5 | 4 |
| Example 9 | — | — | — | 23.8 | 20 | 5.3 | 3.8 | 1.4 | 4 |
| Example 10 | — | — | — | 9 | 150 | 20.8 | 7.2 | 0.9 | 4 |
| Example 11 | — | — | — | 34.9 | 30 | 7.1 | 4.2 | 0.8 | 4 |
| Example 12 | 30 | — | — | −1.5 | 10 | 3.2 | 3.1 | 14.8 | 4 |
| Example 13 | 30 | — | — | 51 | 300 | 38.5 | 7.8 | 14.8 | 4 |
| Example 14 | — | — | — | −13.9 | 20 | 5.7 | 3.5 | 4.9 | 4 |
| Example 15 | — | — | — | 75.8 | 290 | 46 | 6.3 | 2.5 | 4 |
| Example 16 | — | 30 | — | 13.1 | 30 | 9.1 | 3.3 | 14.8 | 4 |
| Example 17 | 30 | — | — | −3.2 | 50 | 11.4 | 4.4 | 14.8 | 4 |
| Example 18 | 29 | — | 1 | −3 | 40 | 9.8 | 4.1 | 14.8 | 4 |
| Example 19 | 30 | — | — | 16.5 | 180 | 32.1 | 5.6 | 14.8 | 4 |
| Example 20 | 15 | — | — | 37.7 | 20 | 5.9 | 3.4 | 10.3 | 4 |
| Comparative | 50 | 50 | — | 57.1 | 150 | 20.5 | 7.3 | 98 | 4 |
| Example 1 | | | | | | | | | |
| Comparative | — | 35 | — | 25.4 | 30 | 9.1 | 3.3 | 36.5 | 4 |
| Example 2 | | | | | | | | | |
| Comparative | 30 | — | — | −7.7 | 150 | 35.7 | 4.2 | 36.5 | 4 |
| Example 3 | | | | | | | | | |
| Comparative | 30 | — | — | 71.8 | 30 | 7.9 | 3.8 | 36.5 | 4 |
| Example 4 | | | | | | | | | |

| | Inorganic dispersion slurry composition | | | | | | |
|---|---|---|---|---|---|---|---|
| | Organic solvent | | | Plasticizer | | Inorganic powder | |
| | | Boiling | Amount | | Amount | | Amount |
| | | point | (% by | | (% by | | (% by |
| | Type | (° C.) | weight) | Name | weight) | Name | weight) |
| Example 1 | Toluene | 110 | 55 | PL-1 | 1 | LLZ | 40 |
| Example 2 | Butyl | 126 | 55 | PL-2 | 1 | LLZ | 40 |
| | acetate | | | | | | |
| Example 3 | Xylene | 139 | 55 | PL-3 | 1 | LLZ | 40 |
| Example 4 | Hexyl | 172 | 55 | PL-1 | 1 | LLZ | 40 |
| | acetate | | | | | | |
| Example 5 | Toluene | 110 | 55 | PL-4 | 1 | LLZ | 40 |
| Example 6 | Butyl | 126 | 55 | PL-5 | 1 | LLZ | 40 |
| | acetate | | | | | | |
| Example 7 | Xylene | 139 | 55 | PL-6 | 1 | LLZ | 40 |
| Example 8 | Hexyl | 172 | 55 | PL-7 | 1 | LLZ | 40 |
| | acetate | | | | | | |
| Example 9 | Butyl | 126 | 55 | PL-8 | 1 | LLZ | 40 |
| | acetate | | | | | | |
| Example 10 | Xylene | 139 | 55 | PL-9 | 1 | LLZ | 40 |
| Example 11 | Hexyl | 172 | 55 | PL-8 | 1 | LLZ | 40 |
| | acetate | | | | | | |
| Example 12 | Toluene | 110 | 55 | PL-1 | 1 | LLZ | 40 |
| Example 13 | Toluene | 110 | 55 | PL-1 | 1 | LLZ | 40 |
| Example 14 | Toluene | 110 | 55 | PL-1 | 1 | LLZ | 40 |
| Example 15 | Toluene | 110 | 55 | PL-1 | 1 | LLZ | 40 |
| Example 16 | Toluene | 110 | 55 | PL-1 | 1 | LLZ | 30 |
| Example 17 | Toluene | 110 | 55 | PL-1 | 1 | LLT | 40 |
| Example 18 | Toluene | 110 | 55 | PL-1 | 1 | LLZ | 40 |
| Example 19 | Toluene | 110 | 55 | PL-1 | 1 | LLZ | 40 |
| Example 20 | Toluene | 110 | 55 | PL-1 | 1 | LLZ | 40 |
| Comparative | Toluene | 110 | 55 | PL-1 | 1 | LLZ | 40 |
| Example 1 | | | | | | | |
| Comparative | Toluene | 110 | 55 | PL-1 | 1 | LLZ | 40 |
| Example 2 | | | | | | | |
| Comparative | Toluene | 110 | 55 | PL-1 | 1 | LLZ | 40 |
| Example 3 | | | | | | | |
| Comparative | Toluene | 110 | 55 | PL-1 | 1 | LLZ | 40 |
| Example 4 | | | | | | | |

TABLE 2

| | | | | | | | Tensile test | | TGDTA |
|---|---|---|---|---|---|---|---|---|---|
| | | | Gelation | Printability | Handleability | Sinterability | Maximum | Elongation | Decomposition |
| | pH of slurry | | of slurry | of slurry | of inorganic | of inorganic | stress | at break | end time |
| | composition | | composition | composition | powder sheet | powder sheet | (N/mm²) | (%) | (min) |
| Example 1 | 11 | A | C | B | C | B | 10 | 70 | 80 |
| Example 2 | 11 | A | C | B | C | B | 12 | 65 | 79 |
| Example 3 | 11 | A | B | B | C | B | 13 | 60 | 78 |
| Example 4 | 11 | A | B | B | C | B | 15 | 70 | 77 |
| Example 5 | 11 | A | B | B | C | B | 10 | 80 | 78 |
| Example 6 | 11 | A | A | B | B | B | 18 | 110 | 78 |
| Example 7 | 11 | A | A | B | B | B | 20 | 120 | 77 |
| Example 8 | 11 | A | A | A | A | A | 28 | 150 | 69 |
| Example 9 | 11 | A | A | A | A | A | 28 | 160 | 69 |
| Example 10 | 11 | A | A | A | A | A | 30 | 170 | 68 |
| Example 11 | 11 | A | A | A | A | A | 30 | 150 | 67 |
| Example 12 | 11 | A | C | B | C | B | 10 | 70 | 79 |
| Example 13 | 11 | A | C | B | C | B | 12 | 65 | 78 |
| Example 14 | 11 | A | A | B | C | B | 13 | 60 | 77 |
| Example 15 | 11 | A | A | B | C | B | 15 | 70 | 78 |
| Example 16 | 10 | B | C | B | C | B | 10 | 80 | 78 |
| Example 17 | 11 | A | C | B | C | B | 12 | 70 | 77 |
| Example 18 | 11 | A | C | B | C | B | 13 | 65 | 78 |
| Example 19 | 11 | A | C | B | C | B | 15 | 60 | 77 |
| Example 20 | 11 | A | B | B | C | B | 15 | 70 | 78 |
| Comparative | 11 | A | D | C | D | C | 9 | 40 | 82 |
| Example 1 | | | | | | | | | |
| Comparative | 11 | A | D | C | D | C | 8 | 30 | 83 |
| Example 2 | | | | | | | | | |
| Comparative | 11 | A | D | C | D | C | 9 | 35 | 81 |
| Example 3 | | | | | | | | | |
| Comparative | 11 | A | D | C | D | C | 8 | 40 | 86 |
| Example 4 | | | | | | | | | |

### INDUSTRIAL APPLICABILITY

The present invention can provide a slurry composition for all-solid-state battery production which can reduce gelation without neutralization with an acidic compound or a capital investment for a large-scale dry room or the like in the production of an all-solid-state battery using an alkali metal-containing inorganic powder, and which enables easy debinding of the binder resin and firing at relatively low temperature. The present invention can also provide a method for producing an all-solid-state battery using the slurry composition for all-solid-state battery production.

1. A slurry composition for all-solid-state battery production, comprising:
an organic solvent;
a binder resin; and
an alkali metal-containing inorganic powder, the binder resin containing a segment (A) derived from a (meth)acrylate having a C3-C20 branched alkyl group and at least one segment (B) selected from the group consisting of a segment derived from a (meth)acrylate having a C5-C20 cyclic hydrocarbon group and a segment derived from a compound having an aromatic group,
the binder resin containing the segment (A) and the segment (B) in a total amount of 70% by weight or more.

2. The slurry composition for all-solid-state battery production according to claim 1, wherein the binder resin contains 20 to 90% by weight of the segment (A).

3. The slurry composition for all-solid-state battery production according to claim 1, wherein the binder resin contains 10 to 80% by weight of the segment (B).

4. The slurry composition for all-solid-state battery production according to claim 1, wherein the slurry composition has a pH of 11 or higher.

5. The slurry composition for all-solid-state battery production according to claim 1, wherein the inorganic powder contains lithium.

6. A method for producing an all-solid-state battery, comprising the steps of:
preparing an inorganic powder sheet using the slurry composition for all-solid-state battery production according to claim 1; and
firing the inorganic powder sheet at 600° C. or lower.
